(19) United States
(12) Patent Application Publication
(10) Pub. No.: US 2024/0020176 A1
(43) Pub. Date: Jan. 18, 2024

(54) METHODS AND APPARATUS FOR DEPLOYMENT OF A VIRTUAL COMPUTING CLUSTER

(71) Applicant: VMware Inc., Palo Alto, CA (US)

(72) Inventors: Miroslav Shipkovenski, Sofia (BG); Petya Aleksandrova, Sofia (BG)

(21) Appl. No.: 17/863,178

(22) Filed: Jul. 12, 2022

(51) Int. Cl. G06F 9/50; G06F 9/38

(52) U.S. Cl. CPC G06F 9/5072; G06F 9/3877; G06F 9/3836

(57) ABSTRACT

Methods, apparatus, systems, and articles of manufacture for deployment of a Kubernetes cluster are disclosed. An example apparatus includes at least one memory; machine readable instructions; and processor circuitry to at least one of instantiate or execute the machine readable instructions to: create a blueprint for the requested deployment of the Kubernetes cluster, identify a zone in which the blueprint is to be deployed, the zone identified based on at least one tag specified in the blueprint, and deploy a resource based on the blueprint, the resource created on a provider instance associated with the selected zone.

### FIELD OF THE DISCLOSURE

This disclosure relates generally to virtualization of computing services, and, more particularly, to methods and apparatus for deployment of a virtual computing cluster.

### BACKGROUND

Virtualizing of computer systems provides benefits such as an ability to execute multiple computer systems on a single hardware computer, replicating computer systems, moving computer systems among multiple hardware computers, dynamically increasing and/or decreasing computing resources allocated to a particular computing service, and so forth.

“Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may include many processing units (e.g., servers). Other components of a cloud computing environment include storage devices, networking devices (e.g., switches), etc. Current cloud computing environment configuration relies on much manual user input and configuration to install, configure, and deploy the components of the cloud computing environment.

### BRIEF DESCRIPTION OF THE DRAWINGS

FIG. 1 illustrates an example environment of use including a software-defined data center (SDDC) implemented in accordance with the teachings of this disclosure.

FIG. 2 is a block diagram illustrating an example implementation of the cluster orchestrator of FIG. 1.

FIG. 3 is a block diagram illustrating an example Kubernetes zone.

FIG. 4 is a flowchart representative of example machine readable instructions and/or example operations that may be executed by example processor circuitry to implement the cluster orchestrator of FIG. 2.

FIGS. 5 and 6 are example user interfaces illustrating the placement of a resource in a Kubernetes zone.

FIG. 7 is a block diagram of an example processing platform including processor circuitry structured to execute the example machine readable instructions and/or the example operations of FIG. 4 to implement the example cluster orchestrator of FIG. 2.

FIG. 8 is a block diagram of an example implementation of the processor circuitry of FIG. 2.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Cloud computing platforms may provide many powerful capabilities for performing computing operations. However, taking advantage of these computing capabilities manually may be complex and/or require significant training and/or expertise. Prior techniques for providing cloud computing platforms and services often require customers to understand details and configurations of hardware and software resources to establish and configure the cloud computing platform. Configuring such cloud computing platforms may involve long running operations and/or complex operations (e.g., a sequence of operations including multiple steps).

A software defined data center (SDDC) is a data storage facility implemented using an infrastructure that is virtualized and delivered as a service to one or more customers. After deployment of a SDDC, the SDDC provides policy-driven automation to enable provisioning and ongoing management of logical compute resources, storage resources, and network resources. For example, customers may select/create policies that cause the SDDC to deploy applications quickly based on policy-driven provisioning that dynamically matches resources to continually changing workloads and business demands. An SDDC can be deployed as a private cloud, a hybrid cloud, or a public cloud and can run on multiple hardware stacks, hypervisors, and clouds.

A virtual machine (VM) is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example.

As used herein, availability refers to the level of redundancy required to provide continuous operation expected for the workload domain. As used herein, performance refers to the computer processing unit (CPU) operating speeds (e.g., CPU gigahertz (GHz)), memory (e.g., gigabytes (GB) of random access memory (RAM)), mass storage (e.g., GB hard drive disk (HDD), GB solid state drive (SSD)), and power capabilities of a workload domain. As used herein, capacity refers to the aggregate number of resources (e.g., aggregate storage, aggregate CPU, etc.) across all servers associated with a cluster and/or a workload domain. In examples disclosed herein, the number of resources (e.g., capacity) for a workload domain is determined based on the redundancy, the CPU operating speed, the memory, the storage, the security, and/or the power requirements selected by a user. For example, more resources are required for a workload domain as the user-selected requirements increase (e.g., higher redundancy, CPU speed, memory, storage, security, and/or power options require more resources than lower redundancy, CPU speed, memory, storage, security, and/or power options).

Many different types of virtualization environments exist. Three example types of virtualization environments are: full virtualization, paravirtualization, and operating system virtualization.

Full virtualization, as used herein, is a virtualization environment in which hardware resources are managed by a hypervisor to provide virtual hardware resources to a virtual machine. In a full virtualization environment, the virtual machines do not have direct access to the underlying hardware resources. In a typical full virtualization environment, a host operating system with embedded hypervisor (e.g., a VMware ESXi™ hypervisor) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical random access memory (RAM) with virtual RAM). Typically, in full virtualization, the virtual machine and the guest operating system have no visibility and/or direct access to the hardware resources of the underlying server. Additionally, in full virtualization, a full guest operating system is typically installed in the virtual machine while a host operating system is installed on the server hardware. Example full virtualization environments include Vmware ESX®, Microsoft Hyper-V®, and Kernel Based Virtual Machine (KVM).

Paravirtualization, as used herein, is a virtualization environment in which hardware resources are managed by a hypervisor to provide virtual hardware resources to a virtual machine and guest operating systems are also allowed direct access to some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

OS virtualization is also referred to herein as container virtualization. As used herein, OS virtualization refers to a system in which processes are isolated in an OS. In a typical OS virtualization system, a host OS is installed on the server hardware. Alternatively, the host OS may be installed in a VM of a full virtualization environment or a paravirtualization environment. The host OS of an OS virtualization system is configured (e.g., utilizing a customized kernel) to provide isolation and resource management for processes that execute within the host OS (e.g., applications that execute on the host OS). Thus, a process executes within a container that isolates the process from other processes executing on the host OS. Thus, OS virtualization provides isolation and resource management capabilities without the resource overhead utilized by a full virtualization environment or a paravirtualization environment. Example OS virtualization environments include Linux Containers LXC and LXD, the DOCKER™ container platform, the OPENVZ™ container platform, etc.

Containerization is an OS virtualization technique used to distribute functions of an application to be executed at different nodes in a cluster (e.g., containerized micro-services). Containerization isolates services running on the same hardware into respective executing environments. A container can be used to place an application or program and its dependencies (e.g., libraries, drivers, configuration files, etc.) into a single package that executes as its own executable environment on hardware. Through such isolation, containerized services are restricted from accessing resources of other containerized services. Container orchestration services can be used to coordinate or orchestrate the deployments and inter-operability of containerized services across geographic regions. Kubernetes® cluster orchestration system is an example of one such container orchestration service. Kubernetes® clusters are often used in environments with many users spread across multiple teams and projects.

Modern day cloud automation platforms offer end users a wide variety of cloud resources for provisioning. These resources are usually exposed through a catalog of templates, which consumers use to deploy cloud applications and services. Infrastructure administrators, on the other hand, make sure that the underlying cloud infrastructure meet the requirements for successful deployment. While administrators take care of details like configuration of cloud providers, placement policies, etc., end users are oblivious to all these practicalities due to the abstraction of the so-called cloud catalog.

The advent of cluster orchestration systems such as Kubernetes has made it practical to deploy and manage container infrastructure and deliver app services running in these containers. As a result, Kubernetes (k8s) resources like k8s clusters, k8s namespaces, and supervisor namespaces/vSphere namespaces have appeared in the automation platforms as catalog items. These k8s resources differ in type, which means that they must be deployed and be managed by different providers. But even resources of the same kind can be supported by multiple providers. In the case of k8s clusters, for example, some of these providers are VMware Tanzu Kubernetes Grid (formerly known as VMware Enterprise PKS), Red Hat OpenShift, and vSphere 7 (Project Pacific). On the other hand, clusters can differ in size (e.g., number of k8s nodes), dedicated physical resources (e.g., compute resources, memory resources, storage resources, accelerator resources, etc.), or be constrained just by the project they are deployed into (e.g., resource quotas, etc.). Similar requirements apply for namespaces. While examples disclosed herein refer to k8s resources, such approaches disclosed herein may also be equally applicable to other virtual cluster orchestration systems.

While catalog users are unable to specify where their k8s deployments may end up, there is a need for placement mechanism that takes the above considerations into account. Example approaches disclosed herein enable creation of a level of abstraction between different types of k8s resources and different types of providers. Example approaches disclosed herein enable users to configure k8s zones to facilitate the deployment of different kinds of k8s resources (e.g., clusters, namespaces, supervisor clusters, etc.) and each of these resources is deployed using a specific type of provider (specified in the zone). Example approaches disclosed herein define techniques for indirect interaction between catalog users and k8s providers, so that providers can receive the right parameters for deployments. Example approaches disclosed herein define a set of limitations based on user-related information like resource quota for a project when addressing resource placement.

A Kubernetes cluster can be used across multiple zones, which represent a logical mapping between cloud resources. As noted above, provisioning of k8s resources like k8s clusters and k8s namespaces, or supervisor namespaces disclosed herein utilize a placement algorithm which operates over a set of policies defined by an administrator. As used herein, such policies used to select a Kubernetes Zone in which a cluster is to be executed. Each zone defines a relation between a provider and a corresponding resource for provisioning. If a user (e.g., an administrator) defines multiple zones that support the same resource type, the user can also assign tags (e.g., keywords/labels) to distinguish between them. A zone can be assigned to a particular project (e.g., a user space on a cloud automation platform) to limit the access to the corresponding provider. In some examples, a value called “zone priority” can be assigned to a zone.

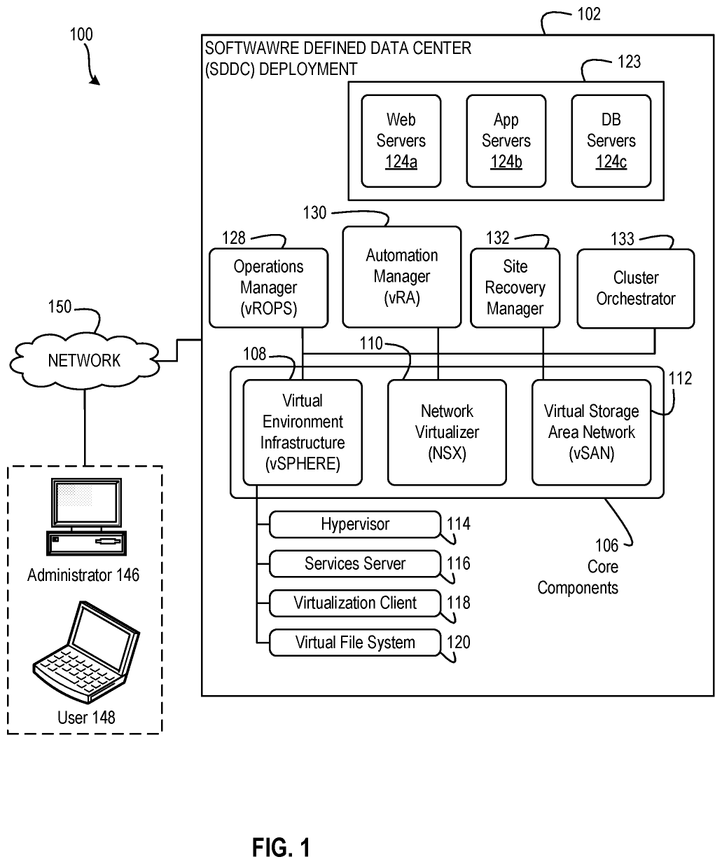

FIG. 1 illustrates an example environment of use 100 including a software-defined data center (SDDC) 102 implemented in accordance with the teachings of this disclosure. The example SDDC 102 of the illustrated example of FIG. 1 includes core components 106, deployed servers 123, an operations manager 128, an automation manager 130, a site recovery manager 132, and a cluster orchestrator 133. An example administrator 146 and/or user 148 access the SDDC 102 via a network 150.

The example core components 106 of the illustrated example include a virtual environment infrastructure 108, an example network virtualizer 110, and an example virtual storage area network 112. The example virtual environment infrastructure 108 is a virtualization platform that includes an example hypervisor 114, an example services server 116, an example virtualization client 118, and example virtual file system 120. In the illustrated example, the virtual environment infrastructure 108 may be implemented using the vSphere virtualization suite developed and sold by VMware® of Palo Alto, California, United States. The example hypervisor 114 may be implemented using the VMware ESXi™ hypervisor developed and sold by VMware®. The example services server 116 may be implemented using the VMware vCenter® Server developed and sold by VMware® The example virtualization client 118 may be implemented using the VMware vSphere® client developed and sold by VMware®. The example virtual file system 120 may be implemented using the VMware vSphere Virtual Machine File System developed and sold by VMware®. Additionally or alternatively, some or all of the components of the virtual environment infrastructure 108 may be implemented using products, software, systems, hardware, etc. from companies other than VMware®. In other examples, the virtual environment infrastructure 108 may include additional or different components other than those shown in FIG. 1.

The example network virtualizer 110 is a network virtualization platform that may be used to provide virtual network resources for network computing environments. The example network virtualizer 110 may be implemented using the VMware NSX® network virtualization platform developed and sold by VMware®. The example virtual storage area network 112 is a data storage virtualization platform that may be used to provide virtual data store resources for network computing environments. The example virtual storage area network 112 may be implemented using the VMware® Virtual SAN™ (vSAN) software-defined storage platform developed and sold by VMware®. Additionally or alternatively, the network virtualizer 110 and/or the virtual storage area network 112 may be implemented using products from companies other than VMware®.

In the illustrated example of FIG. 1, one or more VMs (or containers) are used to implement the deployed servers 123. In the illustrated example, the servers 123 include one or more example web servers 124a, one or more example app servers 124b, and one or more database (DB) servers 124c. The servers 123 are deployed and/or configured by one or more of an example operations manager 128, an example automation manager 130, and an example site recovery manager 132. The example operations manager 128 is provided to automate information technology (IT) operations management of the SDDC 102 to run the servers 123. The example operations manager 128 may be implemented using the VMware® vRealize® Operations (vROPS) IT Operations Management product developed and sold by VMware®. The example operations manager 128 is provided to automate responsive actions to business needs in real-time to deliver personalized infrastructure, applications, and IT operations when business needs arise within the SDDC 102. The example automation manager 130 may be implemented using the VMware's vRealize® Automation (vRA) product developed and sold by VMware®. The example site recovery manager 132 is provided to implement different levels of availability of the SDDC 102 for different servers 123. For example, some servers 123 may require higher levels of redundancy or network rerouting capabilities to ensure a higher level of availability for services (e.g., access to the servers 123 and/or underlying data) even during resource failures. In some examples, other, non-critical servers 123 may only require low to moderate availability. The example site recovery manager 132 may be implemented using the VMware® Site Recovery Manager Disaster Recovery Software developed and sold by VMware®.

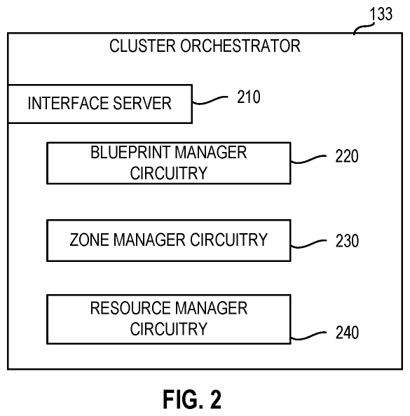

The example cluster orchestrator 133 of the illustrated example of FIG. 1 orchestrates creation of namespaces and permissions within those namespaces. In some examples, the cluster orchestrator 133 implements a placement algorithm that allocates (e.g., assigns) resources to a particular provider instance associated with a zone. A more detailed explanation of the operation of, and components of, the example cluster orchestrator 133 is described in connection with FIG. 2.

FIG. 2 is a block diagram of the example cluster orchestrator 133 of FIG. 1. The example cluster orchestrator 133 of FIG. 2 may be instantiated (e.g., creating an instance of, bring into being for any length of time, materialize, implement, etc.) by processor circuitry such as a central processing unit executing instructions. Additionally or alternatively, the example cluster orchestrator 133 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example cluster orchestrator 133 of the illustrated example of FIG. 2 includes an interface server 210, blueprint manager circuitry 220, zone manager circuitry 230, and resource manager circuitry 240.

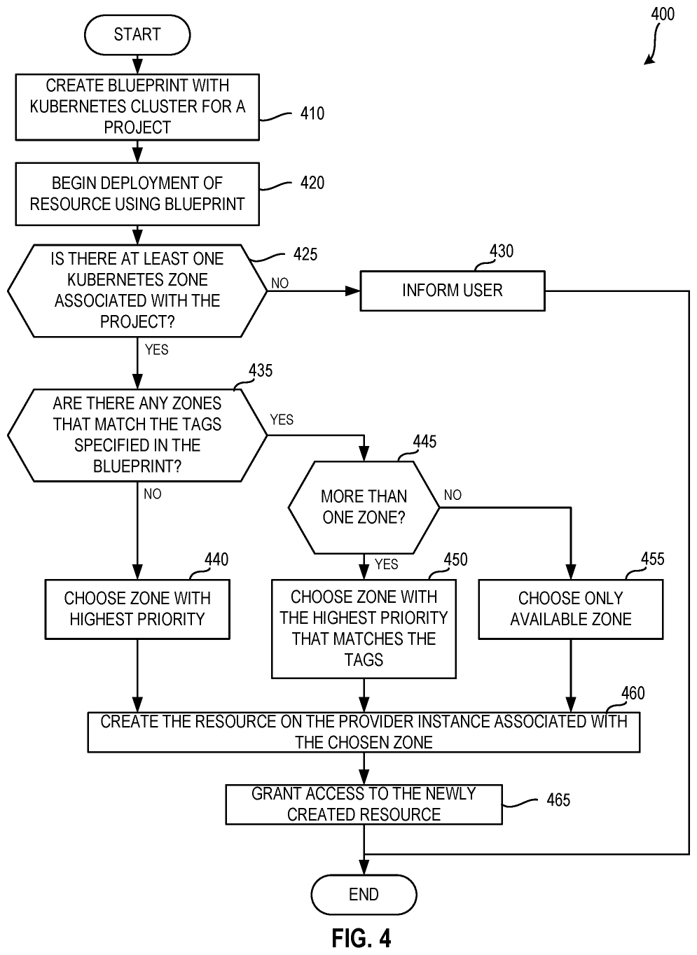

The example interface server 210 of the illustrated example of FIG. 2 receives a request(s) for deployment of a Kubernetes cluster. In some examples, the request(s) originate from a user (e.g., an administrator) that is requesting deployment of a Kubernetes cluster. However, in some examples, the origination of the request may be programmatic in nature. For example, the request may originate from an application that is requesting deployment of a Kubernetes cluster. In some examples, the interface server 210 is instantiated by processor circuitry executing interface server 210 instructions and/or configured to perform operations such as those represented by the flowchart of FIG. 4.

The example blueprint manager circuitry 220 of the illustrated example of FIG. 2 manages blueprints for requested deployments of Kubernetes clusters. The blueprint manager circuitry 220 creates the blueprint based within a specified project (e.g., a user space, a sub-tenant, etc.). In examples disclosed herein, the blueprint includes details about a desired Kubernetes cluster. The blueprint manager circuitry 220 then initializes deployment of the blueprint. In some examples, the blueprint manager circuitry 220 is instantiated by processor circuitry executing blueprint manager instructions and/or configured to perform operations such as those represented by the flowchart of FIG. 4.

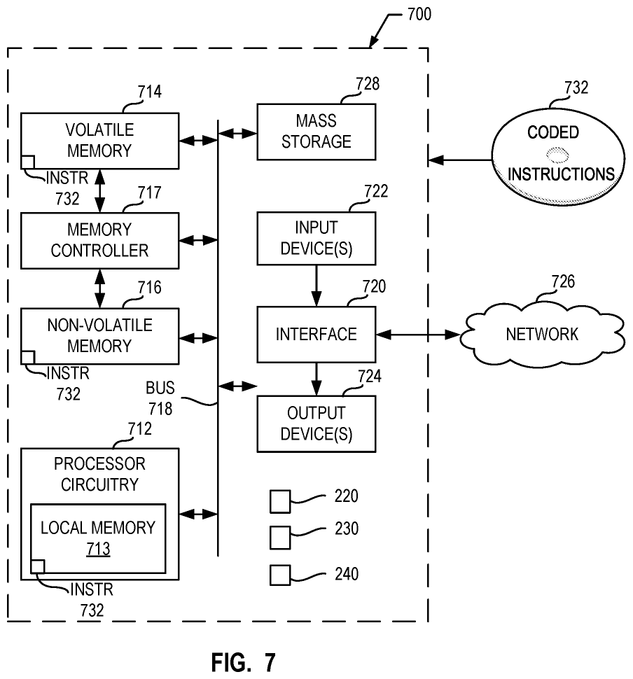

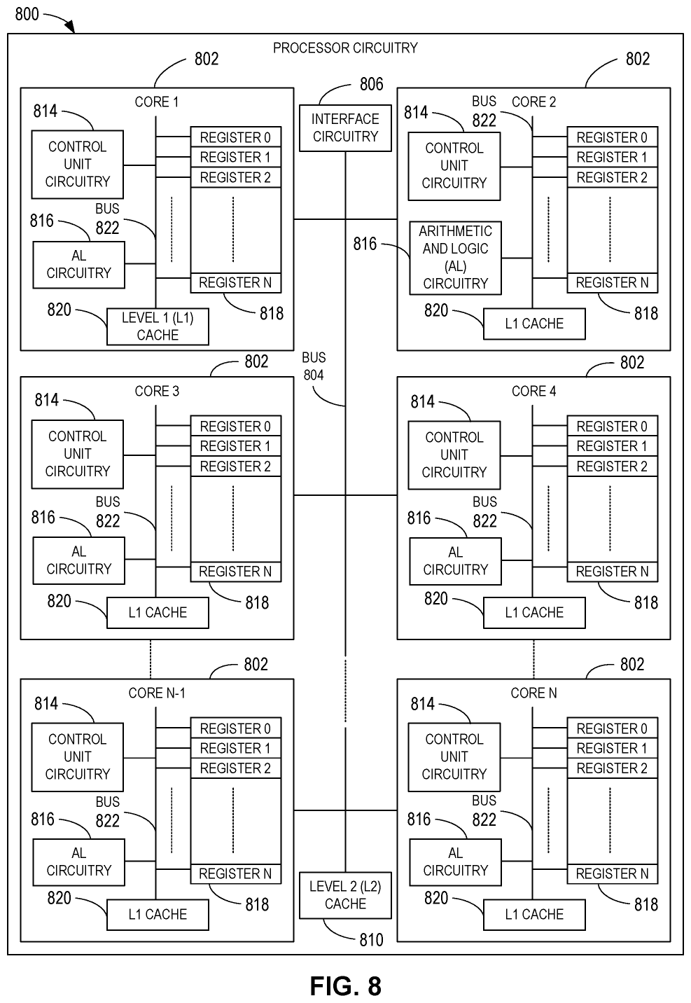

In some examples, the apparatus includes means for creating a blueprint. For example, the means for creating may be implemented by blueprint manager circuitry 220. In some examples, the blueprint manager circuitry 220 may be instantiated by processor circuitry such as the example processor circuitry 712 of FIG. 7. For instance, the blueprint manager circuitry 220 may be instantiated by the example microprocessor 800 of FIG. 8 executing machine executable instructions such as those implemented by at least blocks 410 And 420 of FIG. 4. In some examples, the blueprint manager circuitry 220 may be instantiated by hardware logic circuitry, which may be implemented by an ASIC, XPU, or the FPGA circuitry 800 of FIG. 8 structured to perform operations corresponding to the machine readable instructions. Additionally or alternatively, the blueprint manager circuitry 220 may be instantiated by any other combination of hardware, software, and/or firmware. For example, the blueprint manager circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example zone manager circuitry 230 of the illustrated example of FIG. 2 manages deployment of the blueprint as a resource. The zone management circuitry 230 determines whether there are at least one Kubernetes zone associated with the project. If there are no zones associated with the project, the user is informed of the lack of the zones. In examples disclosed herein, the user is informed via an alert message displayed in a user interface. However, the user may be informed of the lack of the Kubernetes zone(s) in any other manner. For example, an electronic mail message may be sent to the user, a short message service (SMS) message may be sent to the user, etc.

If the example zone management circuitry 230 determines that there is at least one Kubernetes zone associated with the project, the example zone management circuitry 230 determines whether there are any zones that match the tags specified in the blueprint. If no zones match any tags specified in the blueprint, the example zone management circuitry 230 chooses a zone with a highest priority level. If there are zones that match the tags specified in the blueprint, the example zone management circuitry 230 determines if there is more than one zone that matches the tags specified in the blueprint. If the example zone management circuitry 230 determines that more than one zone matches, the example zone management circuitry 230 chooses the zone with the highest priority that matches the specified tags. If the zone management circuitry 230 determines that more than one zone does not match (e.g., there is only a single zone that matches), the example zone management circuitry 230 selects the one zone that is available.

In some examples, the zone management circuitry 230 is instantiated by processor circuitry executing zone management instructions and/or configured to perform operations such as those represented by the flowchart of FIG. 4.

In some examples, the apparatus includes means for identifying a zone in which a blueprint is to be deployed. For example, the means for identifying may be implemented by zone management circuitry 230. In some examples, the zone management circuitry 230 may be instantiated by processor circuitry such as the example processor circuitry 712 of FIG. 7. For instance, the zone management circuitry 230 may be instantiated by the example microprocessor 800 of FIG. 8 executing machine executable instructions such as those implemented by at least blocks 425, 430, 435, 440, 445, 450, and 455 of FIG. 4. In some examples, the zone management circuitry 230 may be instantiated by hardware logic circuitry, which may be implemented by an ASIC, XPU, or the FPGA circuitry 800 of FIG. 8 structured to perform operations corresponding to the machine readable instructions. Additionally or alternatively, the zone management circuitry 230 may be instantiated by any other combination of hardware, software, and/or firmware. For example, the zone management circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example resource manager circuitry 240 of the illustrated example of FIG. 2 creates the resource on the provider instance associated with the zone identified by the zone management circuitry 230. The example resource manager circuitry 240 grants the requesting user (and/or other user(s) and/or group(s) of user(s)) access to the newly created resource. In some examples, the resource manager circuitry 240 is instantiated by processor circuitry executing resource manager instructions and/or configured to perform operations such as those represented by the flowchart of FIG. 4.

In some examples, the apparatus includes means deploying a resource based on a blueprint. For example, the means for deploying may be implemented by resource manager circuitry 240. In some examples, the resource manager circuitry 240 may be instantiated by processor circuitry such as the example processor circuitry 712 of FIG. 7. For instance, the blueprint manager circuitry 220 may be instantiated by the example microprocessor 800 of FIG. 8 executing machine executable instructions such as those implemented by at least blocks 460, 465 of FIG. 4. In some examples, the resource manager circuitry 240 may be instantiated by hardware logic circuitry, which may be implemented by an ASIC, XPU, or the FPGA circuitry 800 of FIG. 8 structured to perform operations corresponding to the machine readable instructions. Additionally or alternatively, the resource manager circuitry 240 may be instantiated by any other combination of hardware, software, and/or firmware. For example, the resource manager circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

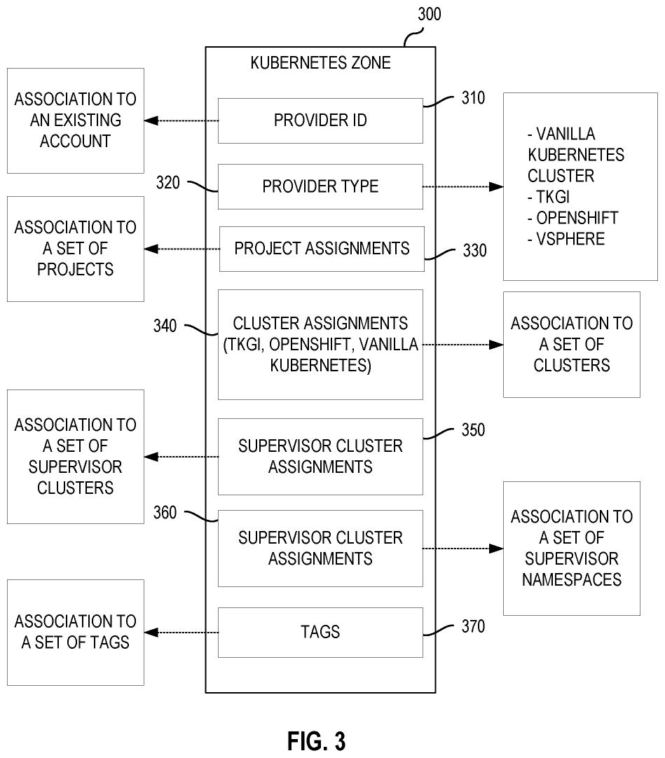

FIG. 3 is a block diagram representing properties of a Kubernetes zone 300. In the illustrated example of FIG. 3, the Kubernetes zone 300 includes a provider id property 310, a provider type property 320, a project assignment property 330, a cluster assignment property 340, a supervisor cluster assignment property 350, a supervisor namespace assignment property 360, and a tag(s) property 370. While such properties are illustrated in the example of FIG. 3, in some examples, a Kubernetes zone might not have and/or might not utilize each of the named example properties. Moreover, in some examples, additional and/or alternative properties may be used in connection with a Kubernetes zone.

The example provider id property 310 of the illustrated example of FIG. 3 establishes an association between the Kubernetes zone and an existing provider. The example provider type property 320 of the illustrated example of FIG. 3 identifies a type of provider including, for example, a vanilla (e.g., stock, unmodified) Kubernetes cluster, Tanzu Kubernetes Grid Integrated Edition (TKGI), OpenShift, vSphere, etc. The example project assignment property 330 of the illustrated example of FIG. 3 identifies an association of the zone with one or more projects. The example cluster assignment property 340 of the illustrated example of FIG. 3 identifies an association of the zone to one or more clusters. The example supervisor cluster assignment property 350 of the illustrated example of FIG. 3 identifies an association of the zone to a set of supervisor clusters. The example supervisor namespace assignment property 360 of the illustrated example of FIG. 3 identifies an association of the zone to a set of supervisor namespaces. The example tag(s) property 370 of the illustrated example of FIG. 3 identifies tags that are associated with the zone.

While an example manner of implementing the cluster orchestrator 133 of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface server 210, the example blueprint manager circuitry 220, the example zone manager circuitry 230, the example resource manager circuitry 240, and/or, more generally, the example cluster orchestrator 133 of the FIG. 1, may be implemented by hardware alone or by hardware in combination with software and/or firmware. Thus, for example, any of the example interface server 210, the example blueprint manager circuitry 220, the example zone manager circuitry 230, the example resource manager circuitry 240, and/or, more generally, the example cluster orchestrator 133 of the FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cluster orchestrator 133 of FIG. 1 may include one or more elements, processes, and/or devices in addition to, or instead of, those illustrated in FIG. 2, and/or may include more than one of any or all of the illustrated elements, processes and devices.

A flowchart representative of example machine readable instructions which may be executed to configure processor circuitry to implement the cluster orchestrator 133 of FIG. 2 is shown in FIG. 4. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 4, many other methods of implementing the example cluster orchestrator 133 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to deploy resources. The machine readable instructions and/or the operations 400 of FIG. 4 begins in response to a request received at the interface server 210 representing a catalog user requesting deployment of a Kubernetes cluster. At block 410, the blueprint manager circuitry 220 creates a blueprint with a Kubernetes cluster. (Block 410). The blueprint manager circuitry 220 creates the blueprint based within a specified project (e.g., a user space, a sub-tenant, etc.). In examples disclosed herein, the blueprint includes details about a desired Kubernetes cluster. The blueprint manager circuitry 220 then initializes deployment of the blueprint. (Block 420). The deployment consists of two phases: allocation (blocks 420 through 455) and provisioning (blocks 460 and 465). The allocation phase determines on which provider the cluster is to be created, while provisioning is the actual deployment. The initialization of the allocation phase triggers a placement algorithm to be performed by the zone management circuitry 230.

The zone management circuitry 230 determines whether there is at least one Kubernetes zone associated with the project. (Block 425). If there are no zones associated with the project, the user is informed of the lack of the zones (block 430), and the example process 400 terminates. In examples disclosed herein, the user is informed via an alert message displayed in a user interface. However, the user may be informed of the lack of the Kubernetes zone(s) in any other manner. For example, an electronic mail message may be sent to the user, a short message service (SMS) message may be sent to the user, etc.

If the example zone management circuitry 230 determines that there is at least one Kubernetes zone associated with the project (e.g., block 425 returns a result of YES), the example zone management circuitry 230 determines whether there are any zones that match the tags specified in the blueprint. (Block 435). If no zones match any tags specified in the blueprint (e.g., block 435 returns a result of NO), the example zone management circuitry 230 chooses a zone with a highest priority level. (Block 440). If there are zones that match the tags specified in the blueprint (e.g., block 435 returns a result of YES), the example zone management circuitry 230 determines if there is more than one zone that matches the tags specified in the blueprint. (Block 445). If the example zone management circuitry 230 determines that more than one zone matches (e.g., block 445 returns a result of YES), the example zone management circuitry 230 chooses the zone with the highest priority that matches the specified tags. (Block 450). If the zone management circuitry 230 determines that more than one zone does not match (e.g., there is only a single zone that matches), the example zone management circuitry 230 selects the one zone that is available. (Block 455).

Following the selection of the zone by the example zone management circuitry 230 in any of blocks 440, 450, or 455, the example resource manager circuitry 240 creates the resource on the provider instance associated with the chosen zone. (Block 460). The example resource manager circuitry 240 grants the requesting user (and/or other user(s) and/or group(s) of user(s)) access to the newly created resource. (Block 465).

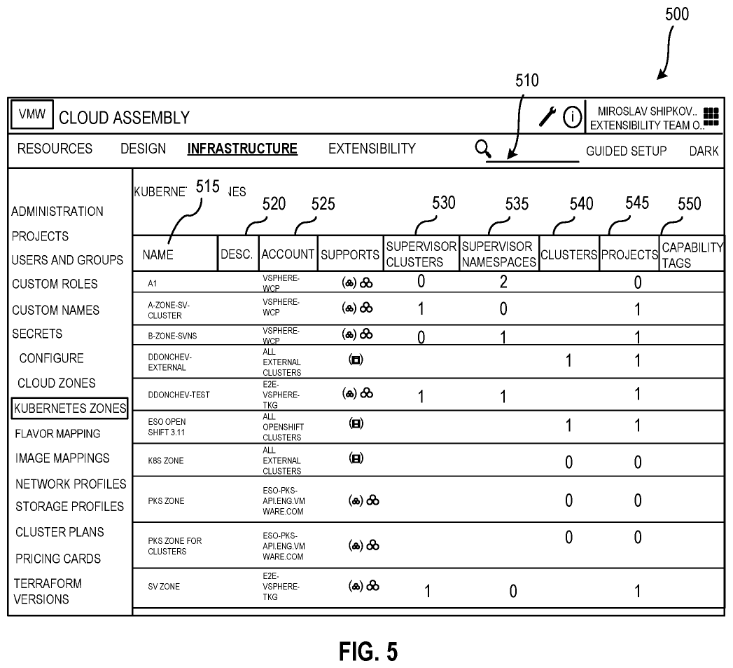

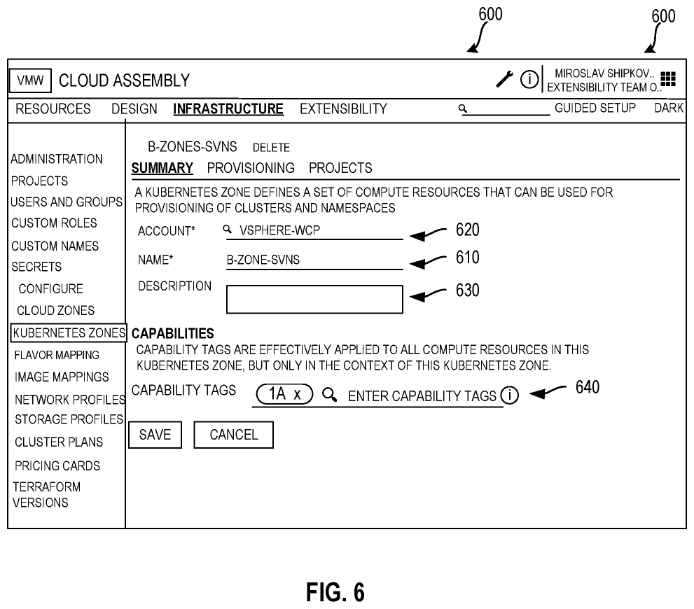

FIGS. 5 and 6 are example user interfaces illustrating the placement of a resource in a Kubernetes zone. In particular, FIG. 5 is a user interface showing a listing of Kubernetes zones. In particular, the example interface 500 of FIG. 5 includes a table 510 having a name column 515, a description column 520, an account column 525, a supervisor clusters column 530, a supervisor namespaces column 535, a clusters column 540, a projects column 545, and a capability tags column 545. The example name column 515 includes a name as provided by a user for the zone. However, names may be generated and/or supplied in any other fashion (e.g., may be programmatically and/or sequentially selected). The example description column 520 includes a description of the zone, if applicable. The example account column 525 indicates which account and/or accounts the zone is applicable to. The example supervisor clusters column 530 indicates a number of supervisor clusters in which the zone is used. The example supervisor namespaces column 535 indicates a number of supervisor clusters in which the zone is used. The example clusters column 540 indicates a number of clusters (e.g., non-supervisor clusters, non-supervisor namespaces, etc.) in which the zone is used. The example projects column 545 indicates a number of projects in which the zone is used. While in the illustrated example of FIG. 5, numeric values are displayed for the example supervisor clusters column 530, the example supervisor namespaces column 535, the example clusters column 540, and the example projects column 545, any other type of data may be displayed in such columns including, for example, a list of relevant data (e.g., clusters, namespaces, projects, etc.). Finally, the capability tags column 550 identifies tags that are associated with a given zone.

FIG. 6 is a user interface 600 showing details for a Kubernetes zone. The example user interface 600 of FIG. 6 includes a zone name field 610, an account field 620, a description field 630, and capability tags field 640. The example zone name field 610 corresponds to the name column 515 of FIG. 5. The example account field 620 corresponds to the account column 525 of FIG. 5. The example description field 630 corresponds to the description column 520 of FIG. 5. The example capability tags field 640 corresponds to the capability tags column 550 of FIG. 5.

FIG. 7 is a block diagram of an example processor platform 700 structured to execute and/or instantiate the machine readable instructions and/or the operations of FIG. 4 to implement the cluster orchestrator 133 of FIG. 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example blueprint manager circuitry 220, the example zone manager circuitry 230, and the example resource manager circuitry 240.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIG. 4, may be stored in the mass storage device 728, in the volatile memory 714, in the non-volatile memory 716, and/or on a removable non-transitory computer readable storage medium such as a CD or DVD.

FIG. 5 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowchart of FIG. 4 to effectively instantiate the circuitry of FIG. 2 as logic circuits to perform the operations corresponding to those machine readable instructions. In some such examples, the circuitry of FIG. 2 is instantiated by the hardware circuits of the microprocessor 800 in combination with the instruction. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIG. 4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

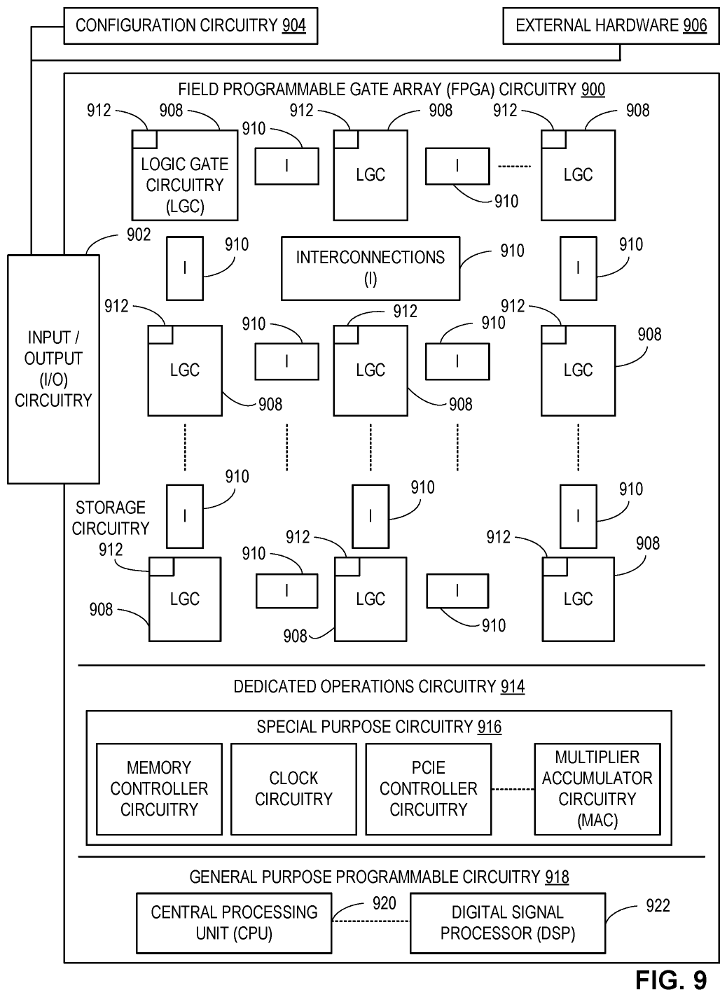

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowchart of FIG. 4 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowchart of FIG. 4. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowchart of FIG. 4. As such, the FPGA circuitry 900 may be structured to effectively instantiate some or all of the machine readable instructions of the flowchart of FIG. 4 as dedicated logic circuits to perform the operations corresponding to those software instructions in a dedicated manner analogous to an ASIC. Therefore, the FPGA circuitry 900 may perform the operations corresponding to the some or all of the machine readable instructions of FIG. 4 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIG. 4 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 5 and 6 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowchart of FIG. 4 may be executed by one or more of the cores 802 of FIG. 8, a second portion of the machine readable instructions represented by the flowchart of FIG. 4 may be executed by the FPGA circuitry 900 of FIG. 9, and/or a third portion of the machine readable instructions represented by the flowchart of FIG. 4 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

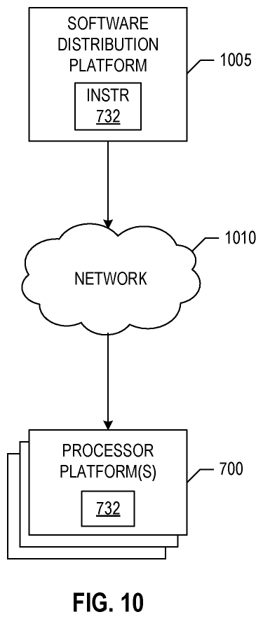

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIG. 4, as described above. The one or more servers of the example software distribution platform 1005 are in communication with an example network 1010, which may correspond to any one or more of the Internet and/or any of the example networks 726 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 4, may be downloaded to the example processor platform 700, which is to execute the machine readable instructions 732 to implement the cluster orchestrator 133. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that enable deployment of Kubernetes resources to appropriate zones based on tags provided in a blueprint and/or priority levels associated therewith. Disclosed systems, methods, apparatus, and articles of manufacture improve the efficiency of using a computing device by enabling more efficient deployment of resources. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for deployment of a Kubernetes cluster are disclosed herein. Further examples and combinations thereof include the following:

Example 1 includes an apparatus for deployment of a Kubernetes cluster, the apparatus comprising interface circuitry to access a request for deployment of a Kubernetes cluster, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate blueprint manager circuitry to create a blueprint for the requested deployment of the Kubernetes cluster associated with a project, zone management circuitry to identify a zone in which the blueprint is to be deployed, the zone identified based on at least one tag specified in the blueprint, and resource manager circuitry to deploy a resource based on the blueprint, the resource created on a provider instance associated with the identified zone.

Example 2 includes the apparatus of example 1, wherein the zone management circuitry is to cause display of an alert in response to a determination that there are no zones associated with the project.

Example 3 includes the apparatus of example 1, wherein the zone management circuitry is to determine whether any zones associated with the project match a tag specified in the blueprint.

Example 4 includes the apparatus of example 3, wherein the zone management circuitry is to choose the zone with the highest priority in response to the determination that no zones associated with the project match the tag specified in the blueprint.

Example 5 includes the apparatus of example 3, wherein the zone management circuitry is to choose the zone with the highest priority that matches the tags in response to a determination that more than one zone matches the tag specified in the blueprint.

Example 6 includes an apparatus to deploy a Kubernetes cluster, the apparatus comprising at least one memory, machine readable instructions, and processor circuitry to at least one of instantiate or execute the machine readable instructions to create a blueprint for a requested deployment of the Kubernetes cluster, identify a zone in which the blueprint is to be deployed, the zone identified based on at least one tag specified in the blueprint, and deploy a resource based on the blueprint, the resource created on a provider instance associated with the identified zone.

Example 7 includes the apparatus of example 6, wherein the processor circuitry is to cause display of an alert in response to a determination that there are no zones associated with the project.

Example 8 includes the apparatus of example 6, wherein the processor circuitry is to determine whether any zones associated with the project match a tag specified in the blueprint.

Example 9 includes the apparatus of example 8, wherein the processor circuitry is to choose the zone with the highest priority in response to the determination that no zones associated with the project match the tag specified in the blueprint.

Example 10 includes the apparatus of example 8, wherein the processor circuitry is to choose the zone with the highest priority that matches the tags in response to a determination that more than one zone matches the tag specified in the blueprint.

Example 11 includes a non-transitory machine readable storage medium comprising instructions that, when executed, cause processor circuitry to at least create a blueprint for a requested deployment of a Kubernetes cluster associated with a project associated with a project, identify a zone in which the blueprint is to be deployed, the zone identified based on at least one tag specified in the blueprint, and deploy a resource based on the blueprint, the resource created on a provider instance associated with the identified zone.

Example 12 includes the non-transitory machine readable storage medium of example 11, wherein instructions cause the processor circuitry to cause display of an alert in response to a determination that there are no zones associated with the project.

Example 13 includes the non-transitory machine readable storage medium of example 11, wherein instructions cause the processor circuitry to determine whether any zones associated with the project match a tag specified in the blueprint.

Example 14 includes the non-transitory machine readable storage medium of example 13, wherein instructions cause the processor circuitry to choose the zone with the highest priority in response to the determination that no zones associated with the project match the tag specified in the blueprint.

Example 15 includes the non-transitory machine readable storage medium of example 13, wherein instructions cause the processor circuitry to choose the zone with the highest priority that matches the tags in response to a determination that more than one zone matches the tag specified in the blueprint.

Example 16 includes a non-transitory machine readable medium comprising blueprint manager instructions to cause at least one machine to create a blueprint for a requested deployment of a Kubernetes cluster associated with a project, zone management instructions to cause the at least one machine to identify a zone in which the blueprint is to be deployed, the zone identified based on at least one tag specified in the blueprint, and resource manager instructions to cause the at least one machine to deploy a resource based on the blueprint, the resource created on a provider instance associated with the identified zone.

Example 17 includes the non-transitory machine readable medium of example 16, wherein zone management instructions cause the at least one machine to cause display of an alert in response to a determination that there are no zones associated with the project.

Example 18 includes the non-transitory machine readable medium of example 16, wherein zone management instructions cause the at least one machine to determine whether any zones associated with the project match a tag specified in the blueprint.

Example 19 includes the non-transitory machine readable medium of example 18, wherein zone management instructions cause the at least one machine to choose the zone with the highest priority in response to the determination that no zones associated with the project match the tag specified in the blueprint.

Example 20 includes the non-transitory machine readable medium of example 18, wherein zone management instructions cause the at least one machine to choose the zone with the highest priority that matches the tags in response to a determination that more than one zone matches the tag specified in the blueprint.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus for deployment of a virtual computing cluster, the apparatus comprising:
interface circuitry to access a request for deployment of a Kubernetes virtual computing cluster; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
blueprint manager circuitry to create a blueprint for the requested deployment of the Kubernetes virtual computing cluster associated with a project;
zone management circuitry to identify a zone in which the blueprint is to be deployed, the zone identified based on at least one tag specified in the blueprint; and
resource manager circuitry to deploy a resource based on the blueprint, the resource created on a provider instance associated with the identified zone.

2. The apparatus of claim 1, wherein the zone management circuitry is to cause display of an alert in response to a determination that there are no zones associated with the project.

3. The apparatus of claim 1, wherein the zone management circuitry is to determine whether any zones associated with the project match a tag specified in the blueprint.

4. The apparatus of claim 3, wherein the zone management circuitry is to choose the zone with the highest priority in response to the determination that no zones associated with the project match the tag specified in the blueprint.

5. The apparatus of claim 3, wherein the zone management circuitry is to choose the zone with the highest priority that matches the tags in response to a determination that more than one zone matches the tag specified in the blueprint.

6. An apparatus to deploy a Kubernetes cluster, the apparatus comprising:
at least one memory;
machine readable instructions; and
processor circuitry to at least one of instantiate or execute the machine readable instructions to:
create a blueprint for a requested deployment of a Kubernetes cluster associated with a project;
identify a zone in which the blueprint is to be deployed, the zone identified based on at least one tag specified in the blueprint; and
deploy a resource based on the blueprint, the resource created on a provider instance associated with the identified zone.

7. The apparatus of claim 6, wherein the processor circuitry is to cause display of an alert in response to a determination that there are no zones associated with the project.

8. The apparatus of claim 6, wherein the processor circuitry is to determine whether any zones associated with the project match a tag specified in the blueprint.

9. The apparatus of claim 8, wherein the processor circuitry is to choose the zone with the highest priority in response to the determination that no zones associated with the project match the tag specified in the blueprint.

10. The apparatus of claim 8, wherein the processor circuitry is to choose the zone with the highest priority that matches the tags in response to a determination that more than one zone matches the tag specified in the blueprint.

11. A non-transitory machine readable storage medium comprising instructions that, when executed, cause processor circuitry to at least:
create a blueprint for a requested deployment of a Kubernetes cluster associated with a project;
identify a zone in which the blueprint is to be deployed, the zone identified based on at least one tag specified in the blueprint; and
deploy a resource based on the blueprint, the resource created on a provider instance associated with the identified zone.

12. The non-transitory machine readable storage medium of claim 11, wherein instructions cause the processor circuitry to cause display of an alert in response to a determination that there are no zones associated with the project.

13. The non-transitory machine readable storage medium of claim 11, wherein instructions cause the processor circuitry to determine whether any zones associated with the project match a tag specified in the blueprint.

14. The non-transitory machine readable storage medium of claim 13, wherein instructions cause the processor circuitry to choose the zone with the highest priority in response to the determination that no zones associated with the project match the tag specified in the blueprint.

15. The non-transitory machine readable storage medium of claim 13, wherein instructions cause the processor circuitry to choose the zone with the highest priority that matches the tags in response to a determination that more than one zone matches the tag specified in the blueprint.

16. A non-transitory machine readable medium comprising:
blueprint manager instructions to cause at least one machine to create a blueprint for a requested deployment of a Kubernetes cluster associated with a project;
zone management instructions to cause the at least one machine to identify a zone in which the blueprint is to be deployed, the zone identified based on at least one tag specified in the blueprint; and
resource manager instructions to cause the at least one machine to deploy a resource based on the blueprint, the resource created on a provider instance associated with the identified zone.

17. The non-transitory machine readable medium of claim 16, wherein zone management instructions cause the at least one machine to cause display of an alert in response to a determination that there are no zones associated with the project.

18. The non-transitory machine readable medium of claim 16, wherein zone management instructions cause the at least one machine to determine whether any zones associated with the project match a tag specified in the blueprint.

19. The non-transitory machine readable medium of claim 18, wherein zone management instructions cause the at least one machine to choose the zone with the highest priority in response to the determination that no zones associated with the project match the tag specified in the blueprint.

20. The non-transitory machine readable medium of claim 18, wherein zone management instructions cause the at least one machine to choose the zone with the highest priority that matches the tags in response to a determination that more than one zone matches the tag specified in the blueprint.
